(19) United States
(12) Patent Application Publication
(10) Pub. No.: US 2006/0036703 A1
(43) Pub. Date: Feb. 16, 2006

(54) System and method for integrating instant messaging in a multimedia environment

(75) Inventors: David R. Fulmer, Redmond, WA (US); Ian H. Todd, Seattle, WA (US); Krishna Ravikumar, Redmond, WA (US); Mark D. MacKenzie, Seattle, WA (US); Sheri L. Lamont, Bellevue, WA (US); Tim Regan, Cambridge (GB)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/917,502

(22) Filed: Aug. 13, 2004

(51) Int. Cl. G06F 15/16

(52) U.S. Cl. 709/207

(57) ABSTRACT

A system and method are provided for combining an instant messaging experience with a primary media experience in a multimedia system. The method includes providing an instant messaging user interface component and displaying the instant messaging user interface component as an overlay on a screen displaying the primary media experience simultaneously with the primary media experience. The displayed instant messaging user interface component occupies a non-central portion of a screen displaying the primary media experience such that both the primary media experience and the instant messaging user interface component are visible to the user. The user interface instant messaging component may include a conversation window having a text entry section and a conversation. The instant messaging user interface enables user access with a remote control device.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to an instant messaging system and more particularly to a system and method for providing instant messaging in conjunction with another primary experience.

### BACKGROUND OF THE INVENTION

Generally, in current computing environments, instant messaging conversations require a user to be near a computer screen. However, home computing use has expanded beyond the traditional personal computing system in which a user sits in front of a computer screen and now encompasses a range of multimedia products. For instance, Windows XP Media Center Edition, produced by the Microsoft Corporation of Redmond, Wash. provides multiple entertainment and computing functions in a single system. Multi-functionality of the multimedia system enables a user to browse the Internet, communicate with other users, play games, watch movies, view photographs, watch television, etc. Windows XP Media Center Edition applications enable viewing of live and recorded television and home videos and editing of digital photographs. Furthermore, the multimedia system may be operated using a remote control device, thus enabling a user to operate the system from anywhere in the room.

The capability to operate the multimedia system remotely requires tailored interaction between a user interface and remote control device. Because a remote control device does not include all of the functionality of a keyboard and cannot point to items on the user interface in the manner of a mouse or other pointing device, specialized interaction between the remote control device and the user interface is often required. Although remote control devices are frequently used for operating a television, CD, or DVD players, a solution is needed that will also operate in conjunction with instant messaging in a multimedia environment.

As set forth above, conventional instant messaging interfaces require a user to be closer to the computer screen than is practical when the computing system also functions as an entertainment center. While at least one system, used for MSN TV and Ultimate TV, exists for instant messaging from a distance, the system does not adequately address balancing the enjoyment of a primary experience, such as watching TV, with engaging in instant messaging conversations. Instead this system implements instant messaging as an entirely separate primary experience rather than as a conjunctive experience. Instant messaging systems for personal computers often display text too small to be read in a multimedia environment.

Accordingly, a solution is needed to address these issues by providing a user experience optimized for media center scenarios. An optimal solution would facilitate sending and receiving messages using a remote control device and/or mouse and keyboard devices and receiving instant messaging notifications that are readable from a distance but that do not interrupt a primary experience.

### BRIEF SUMMARY OF THE INVENTION

Embodiments of the present invention are directed to a method for combining an instant messaging experience with a primary media experience in a multimedia system. The method includes providing an instant messaging user interface component and displaying the instant messaging user interface component as an overlay on a screen displaying the primary media experience simultaneously with the primary media experience. The displayed instant messaging user interface component occupies a non-central portion of a screen displaying the primary media experience such that both the primary media experience and the instant messaging user interface component are visible to the user.

In a further aspect of the invention, a system is disclosed for providing an instant messaging option in combination with a primary media experience in a multimedia environment. The system includes an instant messaging user interface and a media center menu providing entry for a user into the instant messaging user interface. The instant messaging user interface includes two components: a menu for executing commands and initiating a conversation and a conversation window for displaying an active conversation.

In yet a further aspect of the invention, a method is provided for processing received instant messages for a user viewing a primary multimedia experience. The method includes receiving a mode selection from the user of a mode for preventing disturbance of the primary multimedia experience and revising an instant messaging user interface by closing an instant messaging menu and minimizing a conversation window. The method additionally includes receiving and recording or queuing incoming instant messages for the user.

In yet an additional aspect of the invention, an instant messaging user interface is provided for interaction with a remote control device for facilitating conversation during a primary entertainment experience. The instant messaging user interface includes an instant messaging menu for initiating an instant messaging conversation during the primary entertainment experience and a conversation window for display in a peripheral portion of a screen displaying the primary entertainment experience. The conversation window includes a text entry section and a conversation record for displaying conversation history.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is a block diagram illustrating a computerized environment in which embodiments of the invention may be implemented;

FIG. 3 is a screen shot illustrating an instant messaging menu in accordance with an embodiment of the invention;

FIG. 4 is a screen shot illustrating an instant messaging conversation window in accordance with an embodiment of the invention;

FIG. 5 is a screen shot illustrating an entry option into instant messaging in accordance with an embodiment of the invention;

FIG. 6 is a screen shot illustrating a sign-in window in accordance with an embodiment of the invention;

FIG. 7 is an additional screen shot illustrating sign-in options in accordance with an embodiment of the invention;

FIG. 8 is a screen shot illustrating an initial conversation window in accordance with an embodiment of the invention;

FIGS. 9-13 are screen shots illustrating a conversation taking place as displayed in the conversation window in accordance with an embodiment of the invention;

FIGS. 14-17 are screen shots illustrating a conversation window that appears during a file transfer in accordance with an embodiment of the invention;

FIG. 18 is a screen shot illustrating addition of a participant to a conversation in accordance with an embodiment of the invention;

FIG. 19 is a screen shot illustrating a conversation with the added party in accordance with an embodiment of the invention;

FIG. 20 is a screen shot illustrating an instant messaging notification window in accordance with an embodiment of the invention;

FIG. 21 is a screen shot illustrating an instant messaging icon in accordance with an embodiment of the invention

FIG. 22 is a screen shot illustrating a media center menu in conjunction with an instant messaging icon in accordance with an embodiment of the invention; and

FIG. 23 is a flow chart illustrating a do-not-disturb procedure in accordance with an embodiment of the invention.

### DETAILED DESCRIPTION OF THE INVENTION

I. System Overview

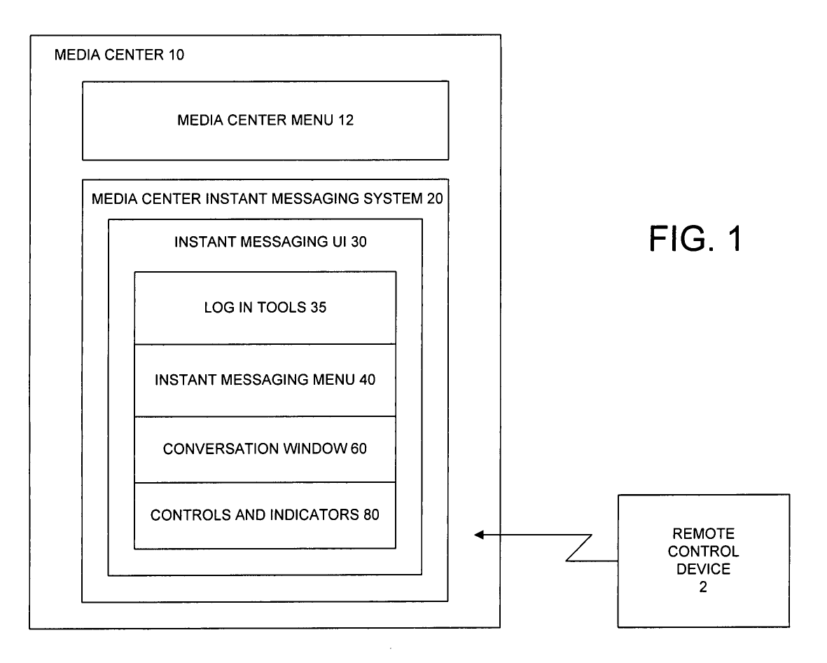

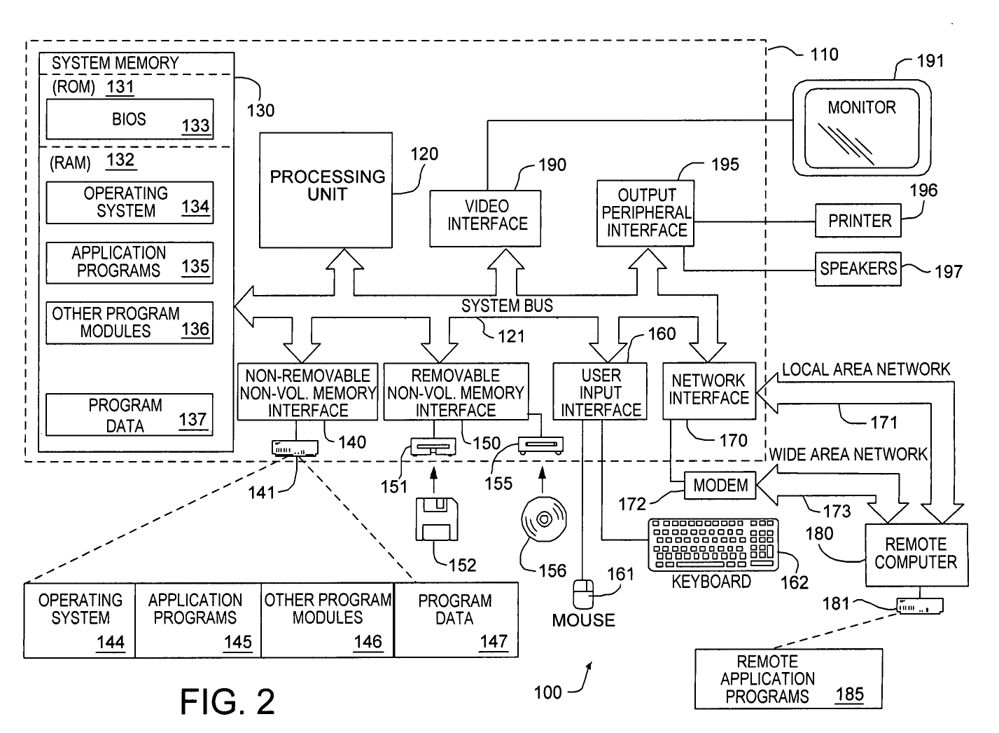

Embodiments of the invention include a method and system for implementing an instant messaging system in a multimedia environment. FIG. 1 is a block diagram illustrating a system in accordance with an embodiment of the invention. A media center 10 includes a media center menu 12 and a media center instant messaging system 20. The media center 10 includes additional components, but is simplified in FIG. 1 to facilitate description of the technique of the invention. The media center instant messaging system 20 includes an instant messaging user interface (UI) 30. The instant messaging UI 30 may include log in tools 35, an instant messaging menu 40, a conversation window 60, and other controls and indicators 80. A remote control device 2 is capable of interacting with the instant messaging UI 30 and its components from a distance. The remote control device 2 may also operate in conjunction with a keyboard and/or mouse (as shown in FIG. 2).

The media center instant messaging system 20 includes improved login scenarios and new instant messaging notifications. The instant messaging system additionally enables sending and receiving of messages using a remote control device 2 and/or a keyboard or mouse, the ability to switch between multiple conversations, and the ability to initiate a new conversation. The instant messaging experience as described herein allows conversations to occur without disrupting the full-screen media experience.

II. Exemplary Operating Environment

FIG. 2 illustrates an example of a suitable computing system environment 100 in which the media center 10 and the media center instant messaging system 20 may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 illustrates a media center instant messaging system 20 operating within a media center 10. A media center menu 12 offers an entry point into the media center instant messaging system 20. Other entry points, such as a start menu or a remote or keyboard button may also be implemented. Entry into the instant messaging system 20 causes components of the instant messaging UI 30 to appear. As will be further explained below, a user can implement the remote control device 2 and/or a keyboard and mouse to interact with the components of the instant messaging UI 30.

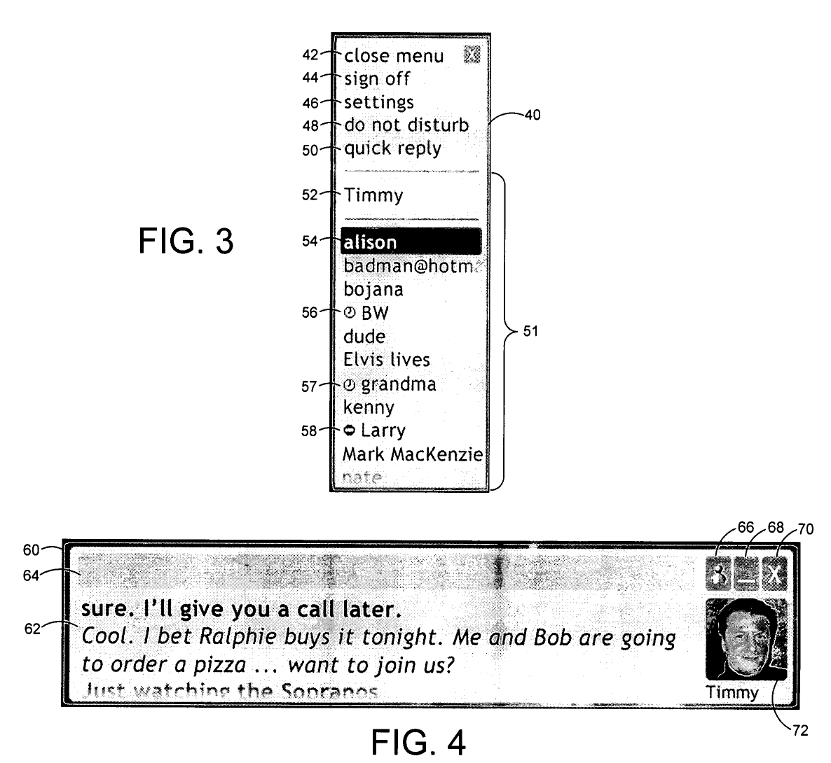

Particulars of the instant messaging UI 30 that will be displayed depend upon whether a user is logged in or signed in when the instant messaging system option is selected. If the user is not logged in to the instant messaging system, the login tools 35 are displayed. If the user is logged in to the instant messaging system, but no active conversations currently exist, only the menu 40 is displayed and focus is set to a first contact on a user's list as will be shown and described below with respect to FIG. 3. If the user is logged in to the instant messaging system and an active conversation exists, the conversation window 60 is displayed showing a conversation record as will be further explained below with respect to FIG. 4 and the focus is set to a text field. If the user is logged in to the instant messaging system and more than one active conversation exists, only the menu 40 is displayed. Accordingly, when the user is logged into the instant messaging system 20, either the menu 40 or the conversation window 60 will typically be available on the UI 30 in order to facilitate instant messaging. When the user is not logged in to the instant messaging system 20, the login or sign-in tools 35 will be displayed.

FIG. 3 is a screen shot illustrating components of the instant messaging system menu 40. The menu 40 provides the capability for selecting a contact and for managing active conversations. The instant messaging system menu 40 may include a close menu option 42. In embodiments of the invention, the close menu command 42 can also be accessed by moving the cursor to the right from anywhere in the menu 40 or by pressing a back button on the remote control device 2. Moving the cursor to the left again returns focus to its previous location. The menu 40 may further include a sign off option 44, a settings option 46, and a “do not disturb” option 48. With the “do not disturb” option 48, a checkbox can be displayed on the menu 40 to indicate this mode is currently turned on. Furthermore, an animation may be displayed as will be further described below, to indicate to other users whether the “do not disturb” mode is on or off. The menu 40 may further include a quick reply option 50. The quick reply option 50 may be selected to save a user's time in order to provide the user with an opportunity to choose from a list of predetermined responses that the user has typed in advance. All of the available commands on the menu 40 will cause the menu 40 to close upon execution.

In addition to the commands described above, the menu 40 may also include a list of contacts 51. After a user initially logs into the instant messaging system 20, the menu 40 is displayed and focus is set to a first selectable contact 54 on a list 51 of contacts. In addition to general selectable contacts as shown on the list 51, the list of contacts 51 may include participants in an active conversation 52, contacts 56, 57, and 58 that are accompanied by a status indicators. The status indicators may indicate any of a plurality of states of a user, such as an away state, a busy state, an online state, an offline state. In order to start a conversation, the user may access contacts from the list 51. For instance, if a user is watching football and would like to invite his brother to watch the game with him, the user finds his brother's name on the list of contacts 51 and initiates the conversation. The list 51 must be able to update itself dynamically as online/offline states change. The user merely selects an additional name on the list of contacts 51 in order to initiate a new conversation or switch between conversations.

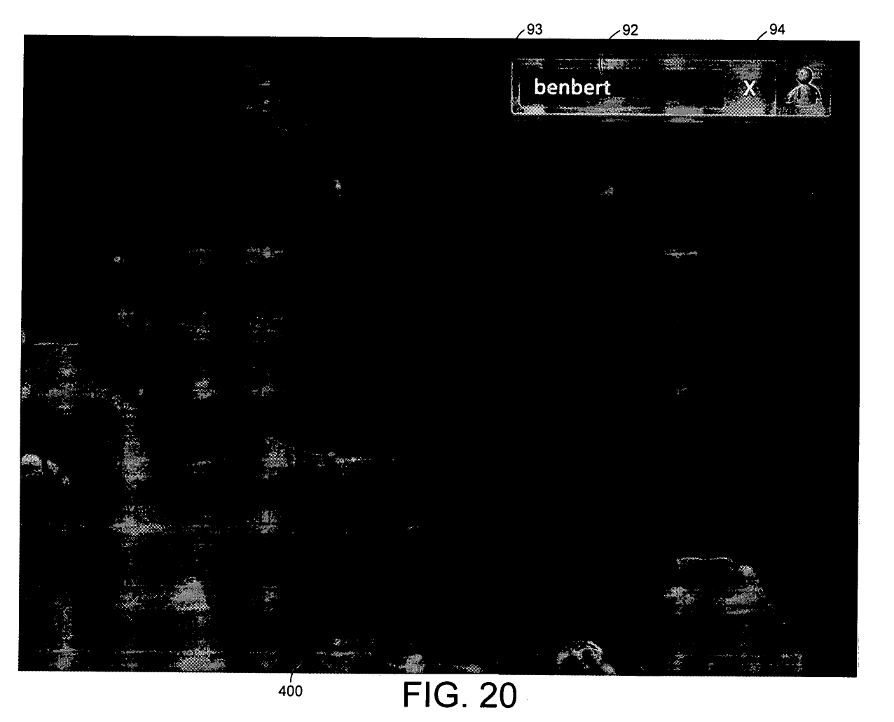

FIG. 4 is a screen shot illustrating components of the conversation window 60 or schematic UI for conducting a conversation in accordance with embodiments of the invention. Within the conversation window 60, users can perform several functions including accepting a conversation, participating in a conversation, and terminating a conversation. New conversations may include a two-person conversation or a three or more person conversation. Users can accept a new conversation using a view message notification 93 as shown in FIG. 20.

The conversation window 60 may have a plurality of states that depend on whether a user is logged in. If the user is logged in, the conversation window 60 may have a normal state, a “do not disturb” state, and a state for accepting an incoming file transfer. The conversation window 60 may also have an inactive or not logged in state.

The conversation window 60 may include a text entry space 64 for entering text and a conversation record 62 for showing recent conversations and information such as information indicating that a participant is typing. The conversation window 60 may also include a show menu button 66, a minimize option 68 for minimizing the conversation window 60, and a close button 70 for closing the conversation window 60. When the minimize option 68 is selected, the conversation window 60 is minimized. However, if the user receives an instant message, the conversation window 60 re-opens. If the user selects the close option 70, the window 60 closes. If the user receives an instant message after selecting the close option 70, the conversation window 60 will not automatically open. Instead, an indicator as described below with respect to FIG. 20 will appear.

The show menu button 66 may cause the menu 40 to be expanded if selected. The show menu button 66 may change configurations by brightening or flashing to indicate that a message is waiting in another conversation or that a message has arrived. The close button 70 may dismiss the conversation and erase the conversation record.

A user tile 72 showing an image of the user or other image or information selected by the user for display to other users may also be shown if available. The user tile 72 may indicate a user state as one of online, away, busy, or offline. Furthermore, a special tile may be used to represent conversations having more than two participants.

As illustrated in the conversation record 62 of FIG. 4, scrollable text is shown using a fade effect. Navigating the conversation record produces two navigation scroll buttons (not shown), one for up and one for down. Scrolling occurs when the focus reaches the bottom of the list, or when the scroll buttons are selected.

The menu 40 and the conversation window 60 have several interaction modes and states. In a closed state, the menu 40 is hidden and can be accessed by clicking the show menu button 66 on the conversation window 60. If the conversation window 60 is not currently displayed, it may appear automatically if a user receives a new message in some circumstances. Focus stays in the conversation window 60 or menu 40 until the window 60 or menu 40 is minimized or closed. If both the conversation window 60 and the menu 40 are open, closing or minimizing one shifts focus to the other. In an open state of the menu 40, focus shifts to the close command at the top of the menu.

Both the conversation window 60 and the menu 40 are accessed and manipulated through the use of the remote control device 2 and a keyboard and/or mouse. Focus moves using UP and DOWN options, on either the remote 2 or the keyboard. Mouse clicks can also activate commands on the menu 40. Most keys on the remote control device 2 function in a standard manner. However, the number keys, the enter key, the clear key, the arrows, and OK button may have specialized functions in order to shift focus and navigate the UI 30. For instance, the arrow and OK buttons may be used to shift focus. Pressing “Clear” on the remote control device 2 automatically deletes text in the text entry field 62. Pressing OK on the remote control device 2 automatically sends the text in the text entry section 62. Pressing the “send” button may also send the message in the text entry field 62.

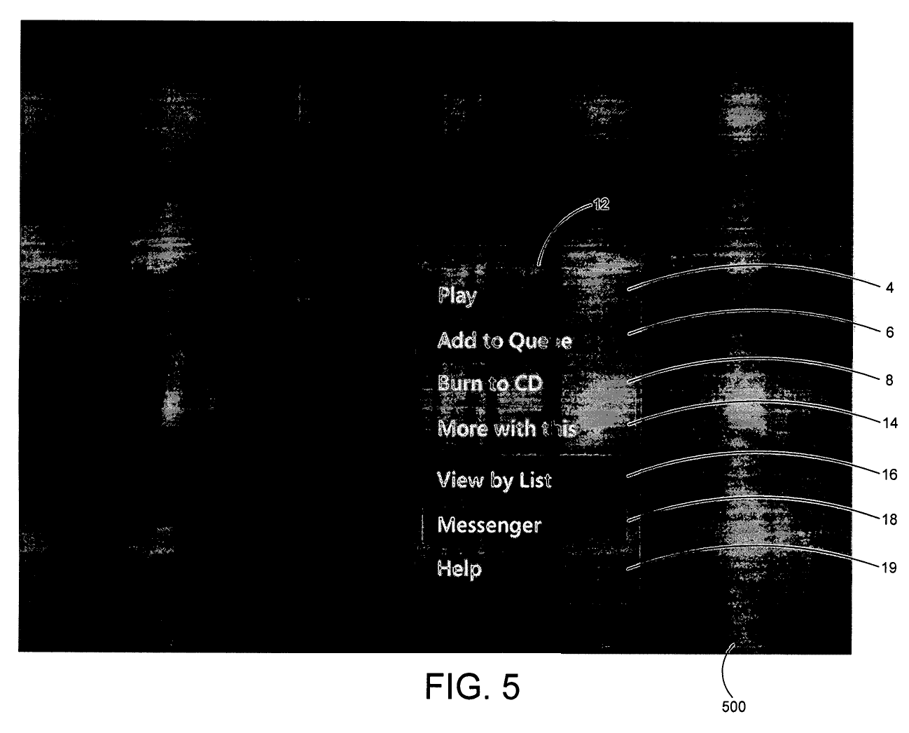

FIG. 5 is a screen shot illustrating a scene 500 from a television show, movie, or video. In a portion of the screen 500, a media center menu 12 is shown in accordance with an embodiment of the invention. The media center menu 12 may include a plurality of options including a play option 4, an add to queue option 6, a burn to CD option 8, a more with this option 14, a view by list option 12, a messaging system option 18, and a help option 19. The aforementioned options entail interaction between the user and available entertainment sources. A messaging system option 18 offers a user an entry point into the media center instant messaging system 20. By selecting the messaging system option 18, a user will be presented with one or more elements of the instant messaging UI 30.

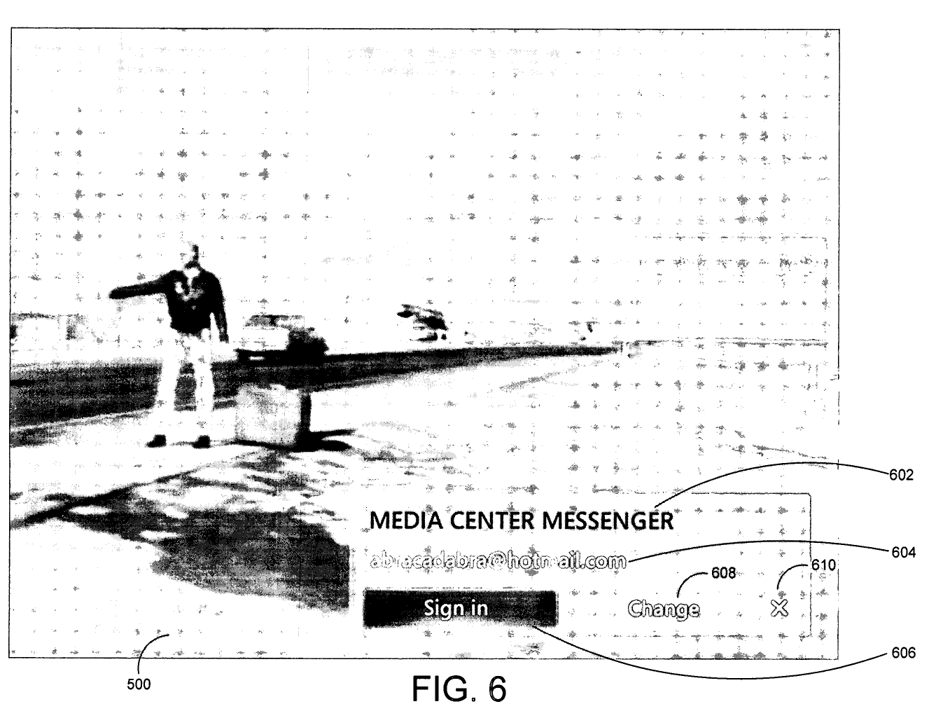

As shown in FIG. 6, after selecting the messaging option 18, a sign-in message 602 may appear. The sign-in message 602 occupies a small portion of the viewing screen 500. In embodiments of the invention, the sign-in message 602 occupies one third or less of the screen 500. The sign-in message 602 includes a space 604 for entry of an email address, a sign-in selection button 606, a change selection button 608, and a close selection button 610. The change selection button 608 enables a user to change the email address entered in the space 604 in order to sign in for an alternate account.

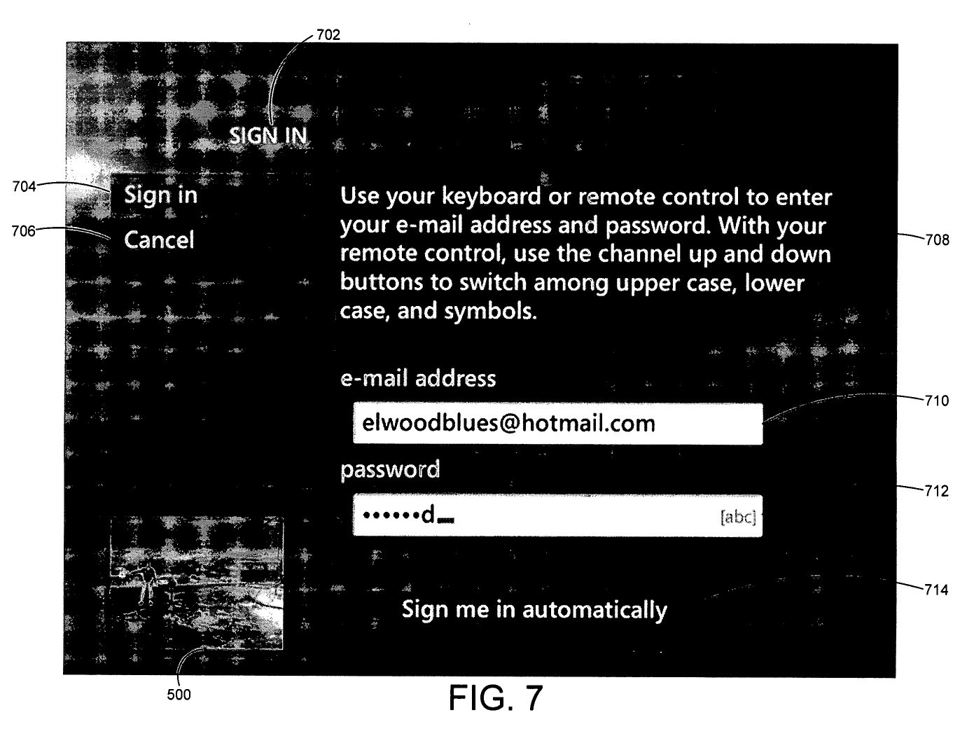

FIG. 7 illustrates a further embodiment of the sign-in screen. In FIG. 7, the scene 500 from the movie, video, or television show is minimized to occupy a small portion of the viewing screen 702. A sign-in option 704 and a cancel option 706 are available on the screen 702. An instructional section 708 may provide a user with sign-in instructions. A user email address may be entered in an email address block 710. A password may be entered in a password block 712. An option 714 may be provided for automatic sign-in. Using the automatic sign-in option 714, a user may designate whether the user would like to use the media center instant messaging system while using media center. In order allow automatic sign-in, the system may require the user to initially enter credentials such as email address and password. After the initial entry, automatic sign-in will occur unless the user cancels the action.

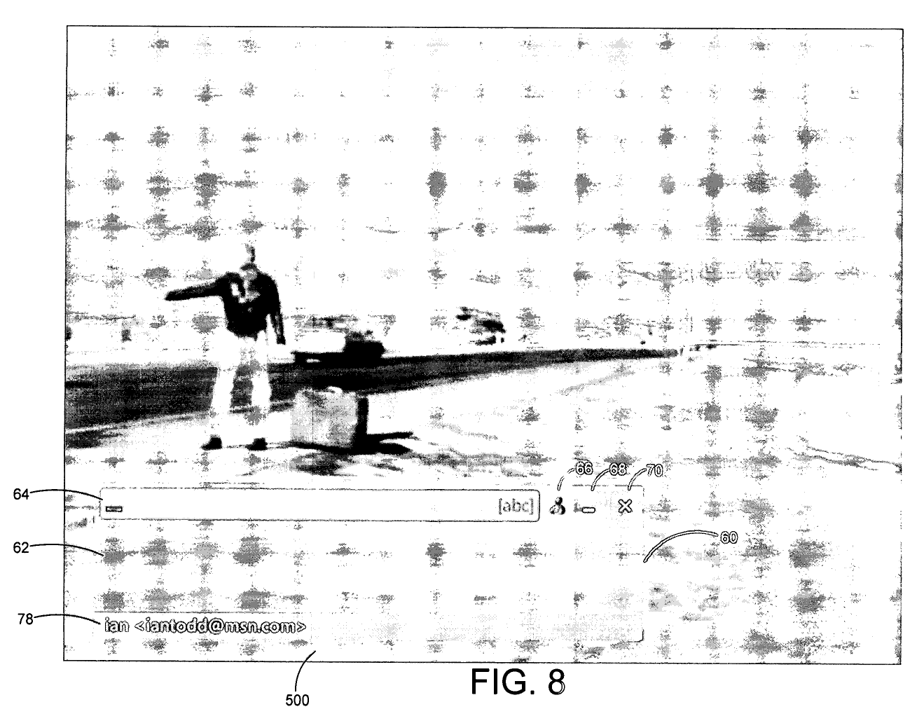

FIG. 8 illustrates a conversation window 60 that appears once the user has signed in using the sign-in tools or login tools shown in FIG. 6 or FIG. 7. The conversation window 60 may include a text entry portion 64, a show menu button 66, a minimize option 68, and a close option 70. A conversation may be recorded in the section 62 and a users email address may appear in a section 78. The conversation window 60 is shown as occupying a small portion of the video, movie, or television show 500 being viewed by the user. In this manner, a user can conduct a conversation without obstructing viewing of the main feature. As illustrated in FIG. 8, after initial sign-in, focus in the conversation window 60 is automatically set to the text entry portion 64.

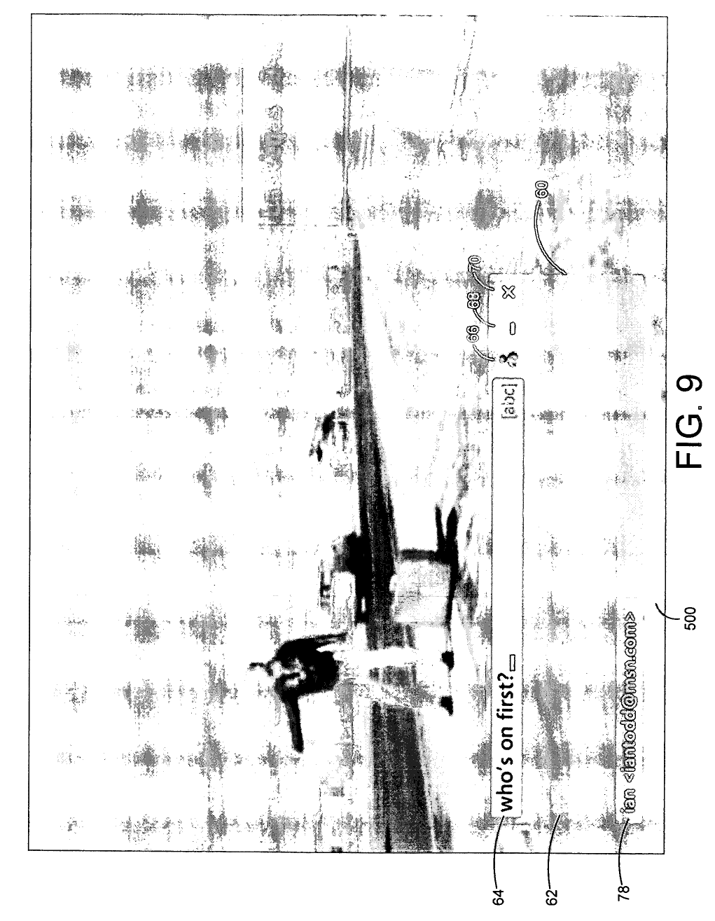

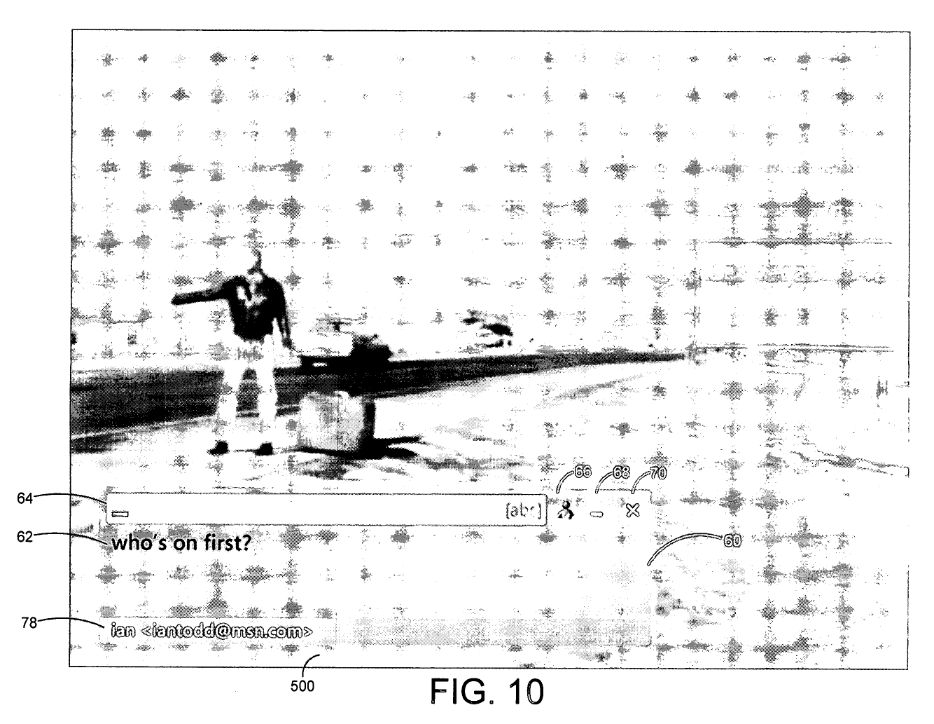

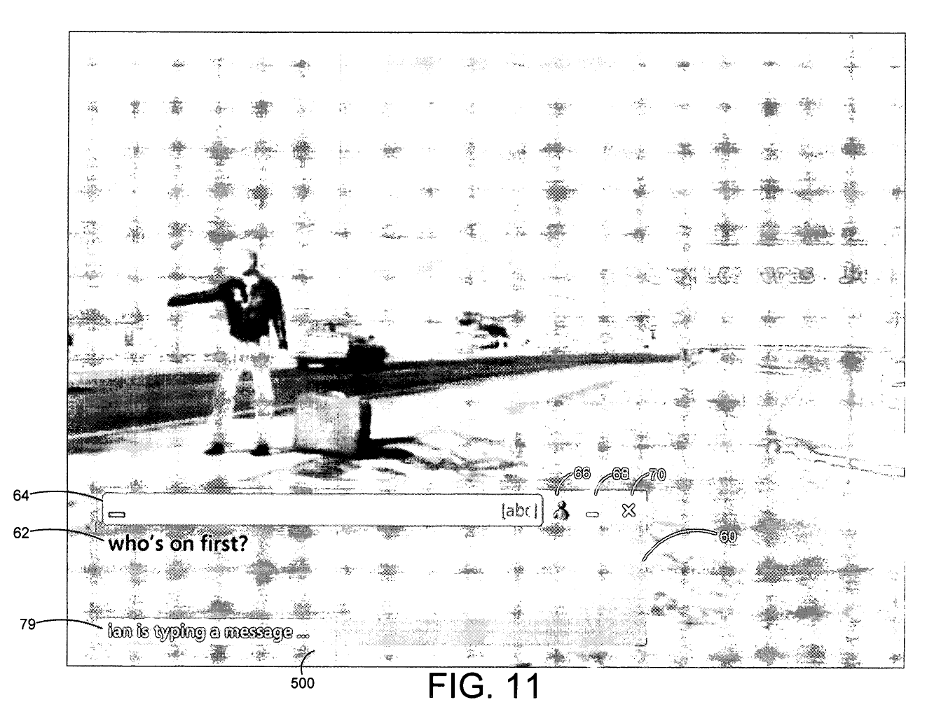

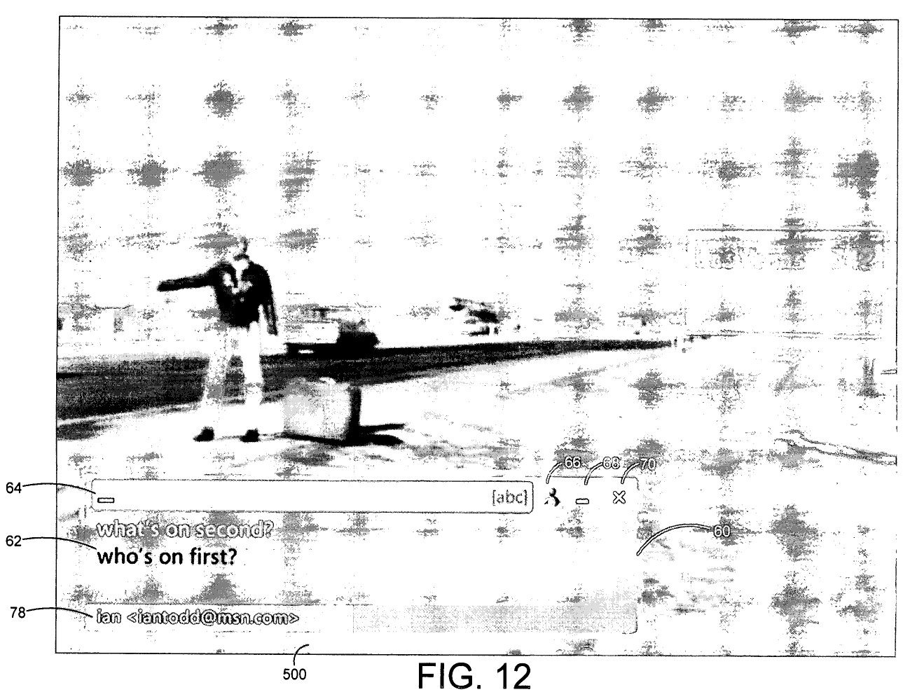

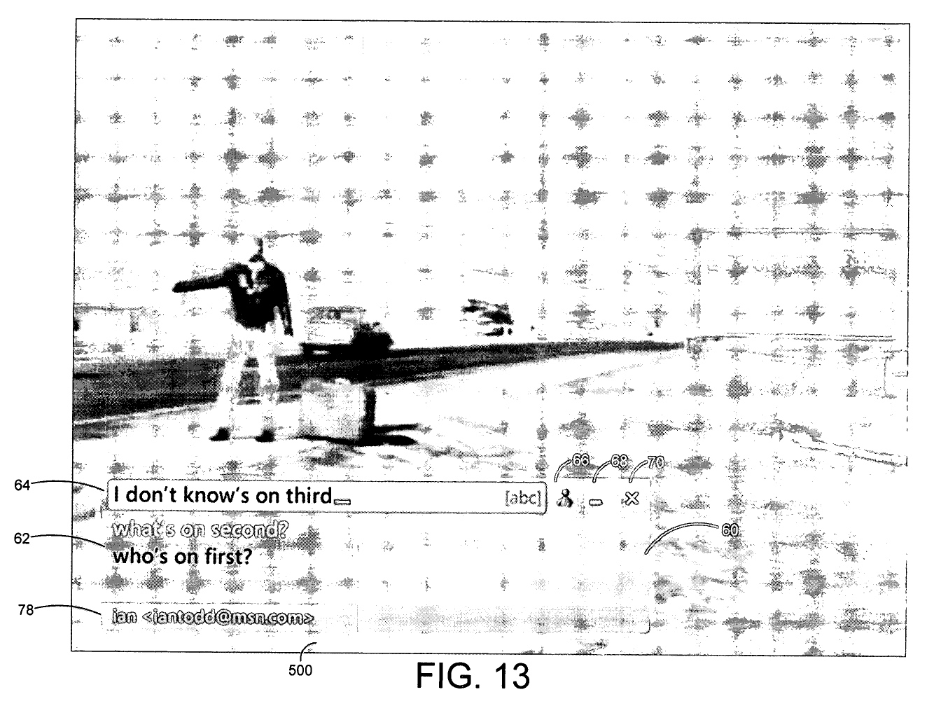

FIG. 9 illustrates the conversation window 60 after a user has begun typing a message “Who's on first?” in the section 64 of the conversation window 60. FIG. 10 illustrates the conversation window 60 with the conversation recorded in section 62 and a prompt to another user to type a reply in section 64. FIG. 11 illustrates a conversation window 60 in which the conversation is recorded in section 62, a prompt is provided at 64, and an indicator 79 provides information that a user is typing a message. FIG. 12 shows a new message typed in section 62. FIG. 13 illustrates a further response 64.

Additional reference numerals in FIGS. 9-13 represent the same features as described above with reference to FIG. 8.

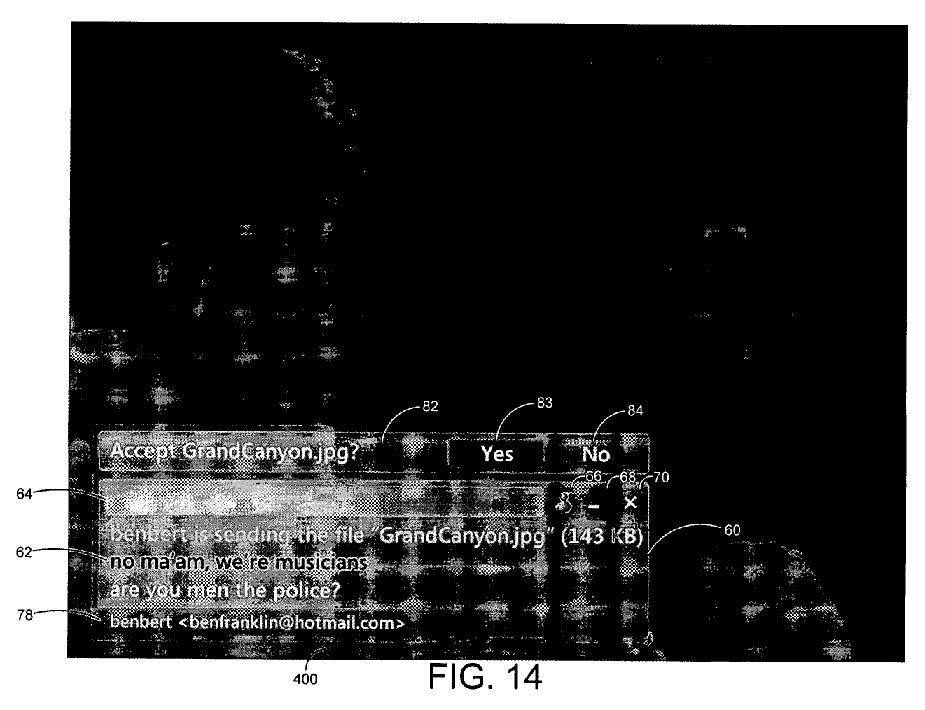

FIG. 14 illustrates conversation window 60 in which a user is attempting to transfer a file. A file transfer indicator 82 is provided at the top of the conversation window 60. The user can accept the file transfer by selecting a “yes” selection button 83 or can decline the file transfer by selecting a “no” selection button 84. An indication that a sender is transferring a file and an indication of the size of the file are provided in the conversation record 62 once the user has activated the “yes” selection button 83. However, new messages can be received while the “yes” and “no” selection buttons 83 and 84 are being displayed. The conversation window 60 is substantially as described above with reference to FIG. 8.

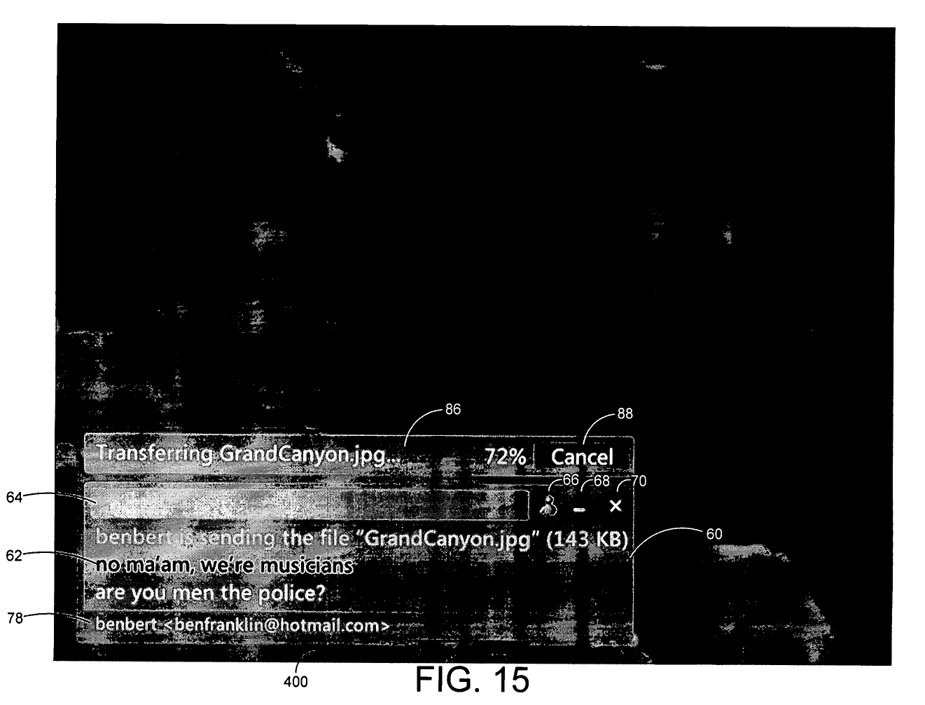

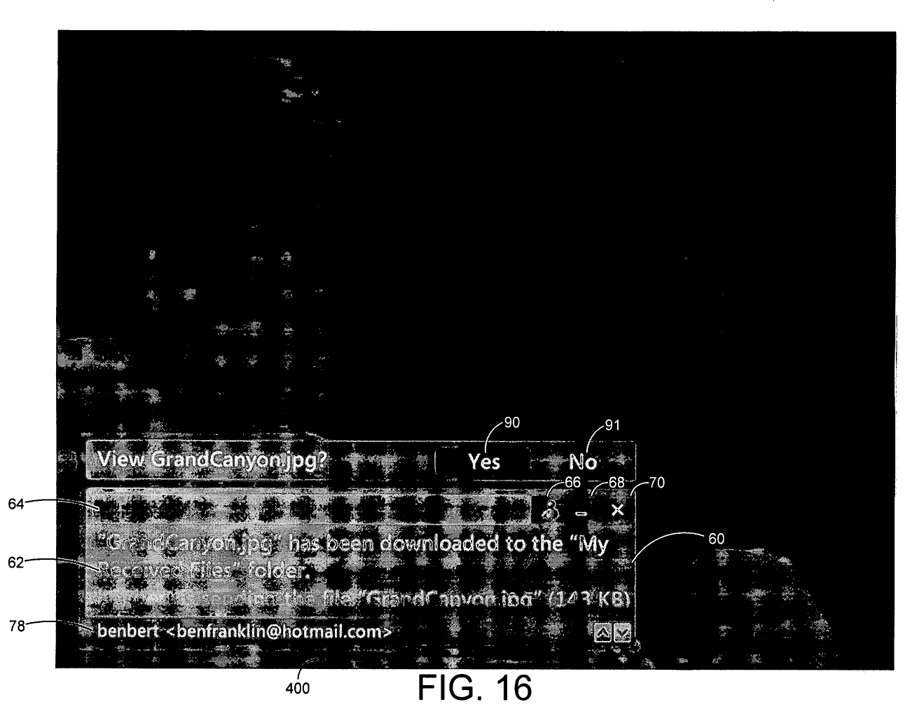

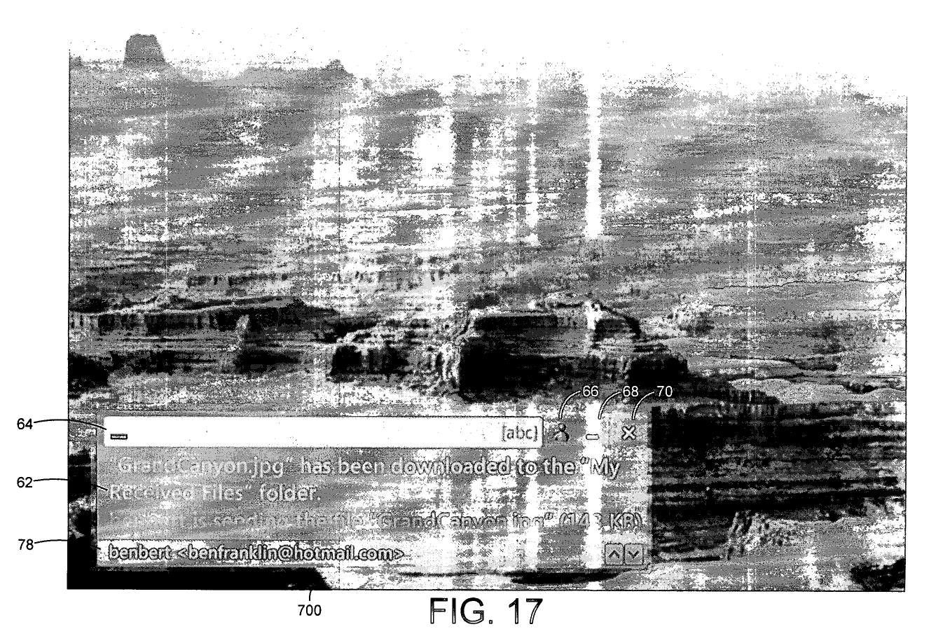

If the user selects the “yes” selection button 83, a message 86 as shown in FIG. 15 indicates that the file is being transferred. The user may select a cancel option 88. In FIG. 16, the file transfer is complete and the user is provided with an option 90 to view the transferred file. The user may also decline to view the transferred file by selecting a “no” selection button 91. In this instance, the transferred file is the Grand Canyon. In the conversation window 60, an indication was initially provided of the file and the sender. After the file is transferred an indication is provided that the file has been downloaded to its current location. If the viewer selects the “yes” selection button option 90 of FIG. 16, the scene 700 of FIG. 17 appears. The conversation window 60 remains as described above with focus returned to the text entry section 64.

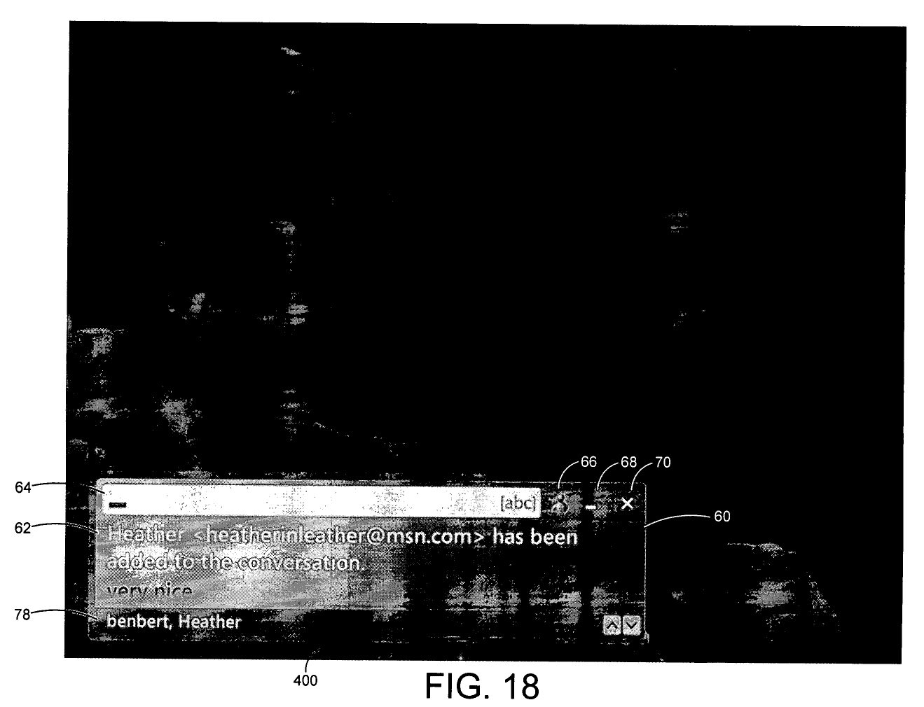

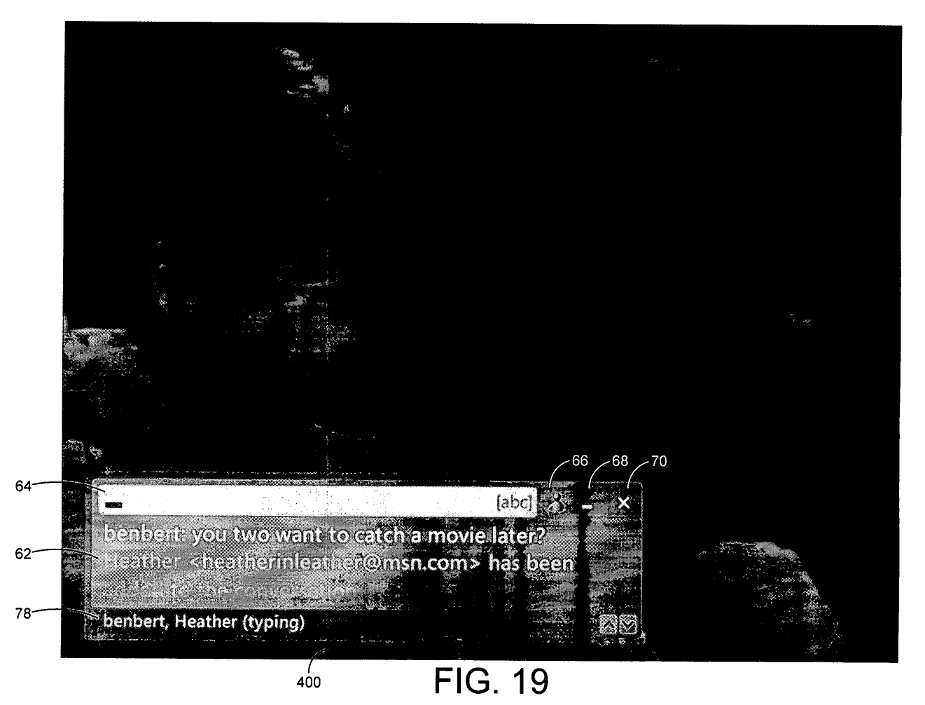

FIG. 18 illustrates a conversation window 60 that indicates in the conversation record 62 that a user, Heather, has been added to the conversation. FIG. 19 illustrates a conversation window 60 having a recorded conversation 62 between benbert and Heather. An indicator 78 indicates that Heather is typing. The described system is capable of allowing multiple users to participate in a single conversation. When an invitation is received and accepted, a special line of text, such as that provided in FIG. 18, appears in the message history indicating that the new user has joined the conversation.

FIG. 20 illustrates a new message indicator 93 on the screen 400. The new message indicator 93 provides a sender indication 92, and a close selection option 94.

This type of new message indicator 93 is shown when the user is watching a main feature and is currently signed into the instant messaging system 20. The message itself will not be displayed unless the user selects the new message indicator 93.

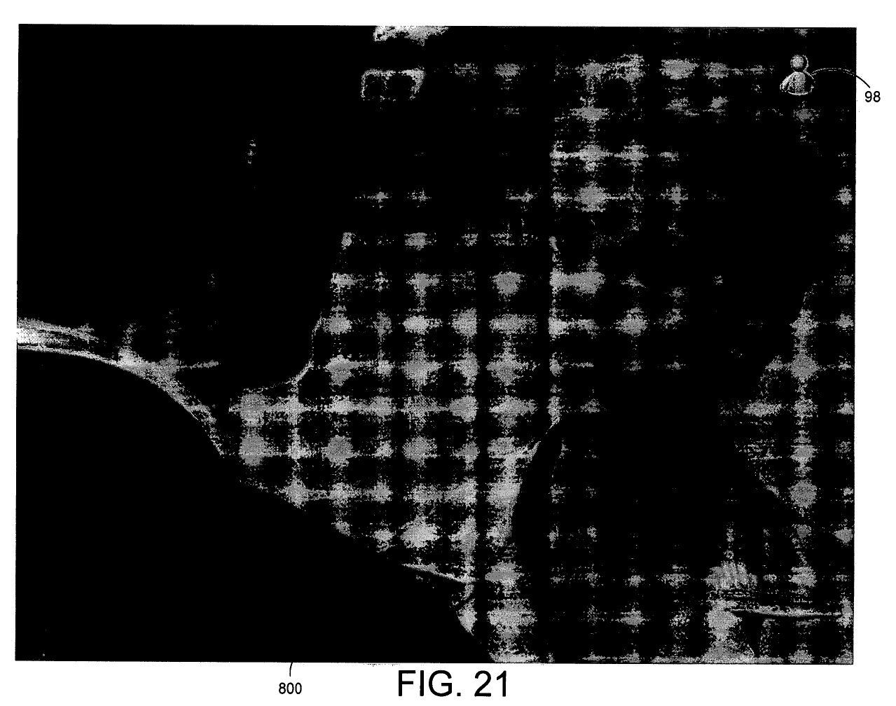

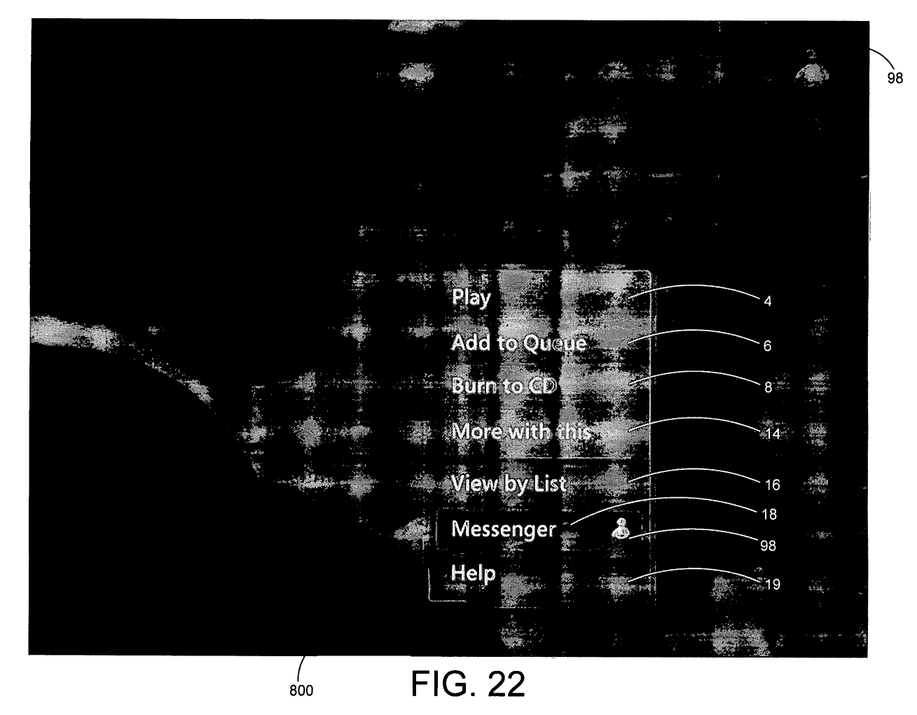

FIGS. 21 and 22 also provide a visual status indicator 98 on a screen 800. The visual status indicator 98 in FIG. 21 is shown in an upper right corner of the screen 800 and does not obstruct the screen 800. The visual status indicator 98 may be present so that a user has ongoing notification of log in status. In FIG. 22, the visual status indicator 98 is also shown in combination with the menu 12. The instant messaging system access section 18 of the menu 12 also includes the visual status indicator 98. In FIG. 22, focus has shifted to the menu 12. As illustrated in FIG. 22, the status indicator 98 may also appear as a transparent instant messaging system overlay icon in the upper-right corner of the screen whenever a new message is waiting.

In an embodiment of the invention, a plurality of visual status indicator states may be provided. If the user is logged into the instant messaging system and a new message is waiting, then the indicator may appear in the menu 40 and as an overlay icon 98. If the user is logged in, but no new message is waiting, then the indicator may only appear on the menu 40. If a change in state is in progress, then the indicator may appear only as on overlay icon as shown in FIG. 21. As set forth above with respect to FIG. 4, if the user is logged on, but has closed the conversation window 60, the indicator 93 may appear on the screen.

After accepting the new instant message, the user is able to view the message from a friend. At any time the user may choose to sign out of the instant messaging system 20. This command may result in a visual confirmation that the user is no longer logged into messenger. The confirmation occurs when the visual status indicator 98 and/or the instant messaging UI 30 disappears.

FIG. 23 illustrates a technique for implementing a “Do Not Disturb” option in accordance with an embodiment of the invention. The process begins in step 200. In step 210, the instant messaging system 20 receives a “Do Not Disturb” selection from the user through the menu 40 shown in FIG. 3. In step 220, the instant messaging system 20 revises the UI 30 in response to the selection. In step 230, the instant messaging system 20 accepts and records incoming messages until the process ends in step 240. When the user deactivates the “Do Not Disturb” option, the user will be able to view and interact with the accepted and recorded messages as seen in the list of conversations in the menu 40.

The revision to the UI 30 of step 220 includes minimization of any open conversation windows 60 and closing of the menu 40. A checkbox may be displayed on the menu 40 to indicate the “Do not Disturb” mode is currently turned on. An animation may also be displayed to provide other users with an indication that this user is in “Do Not Disturb” mode. Whereas, a user who is logged off cannot receive messages sent during the logged off period, a user who is in “do not disturb” mode will receive sent instant messages upon deactivation of the mode. When the user deactivates the “Do Not Disturb” mode, the system sets the instant messaging presence to active and closes the menu 40. Additionally, any new incoming messages return to their normal behavior. The checkbox and animation are removed.

With the instant messaging system described above, users are able to view a main feature and simultaneously discuss the main feature with other users. Furthermore, users are able to conduct conversations unrelated to the main feature without obstructing enjoyment of the main feature.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for combining an instant messaging experience with a primary media viewing experience in a multimedia system, the method comprising:
providing an instant messaging user interface component;
displaying the instant messaging user interface component as an overlay on a screen displaying the primary media viewing experience simultaneously with the primary media viewing experience, wherein the displayed instant messaging user interface component occupies a non-central portion of a screen displaying the primary media viewing experience such that both the primary media experience and the instant messaging user interface component are visible to the user.

2. The method of claim 1, further comprising providing a media center menu that includes an entry point for accessing the instant messaging experience.

3. The method of claim 1, further comprising providing a conversation window as the instant messaging user interface component, the conversation window providing a space for conversation during the primary media viewing experience.

4. The method of claim 3, further comprising providing a text entry section for entering text and a conversation record for displaying a current conversation in the conversation window.

5. The method of claim 3, further comprising providing an instant messaging menu for accessing the conversation window.

6. The method of claim 5, further comprising providing a selectable button on the conversation window for accessing the instant messaging menu.

7. The method of claim 5, further comprising providing a disturbance prevention mode on the instant messaging menu, wherein the disturbance prevention mode processes and records messages received during the primary media viewing experience.

8. The method of claim 5, further comprising providing a quick reply option on the instant messaging menu for allowing the user to select one response from of a set of predetermined responses.

9. The method of claim 5, further comprising providing a contact list on the instant messaging menu for allowing the user to initiate a conversation and open a conversation window.

10. The method of claim 5, further comprising closing the instant messaging menu upon execution of any command from the instant messaging menu.

11. The method of claim 1, further comprising providing a message waiting notification symbol to notify the user that at least one message is waiting.

12. The method of claim 11, further comprising varying an appearance of the message waiting notification symbol in order to convey message status.

13. A computer readable medium storing computer executable instructions for performing the method of claim 1.

14. A system for providing an instant messaging option in combination with a primary media experience in a multimedia environment, the system comprising:
an instant messaging user interface; and
a media center menu providing entry for a user into the instant messaging user interface,
the instant messaging user interface comprising an instant messaging menu for executing commands and initiating a conversation and a conversation window for displaying an active conversation.

15. The system of claim 14, wherein the conversation window comprises a text entry section for entering text and a conversation record section for displaying the active conversation.

16. The system of claim 14, further comprising a show menu button on the conversation window for accessing the instant messaging menu.

17. The system of claim 14, further comprising a selectable disturbance prevention mode on the instant messaging menu, wherein the disturbance prevention mode processes and records messages received during the primary media experience.

18. The system of claim 14, further comprising a quick reply option on the instant messaging menu for allowing the user to select one response from of a set of predetermined responses.

19. The system of claim 14, further comprising a contact list on the instant messaging menu for allowing the user to initiate a conversation and open a conversation window.

20. The system of claim 14, further comprising a message waiting notification symbol to notify the user that at least one message is waiting.

21. The system of claim 14, further comprising a message waiting notification symbol having a varying appearance in order to convey message status.

22. A method for processing received instant messages for a user viewing a primary multimedia experience, the method comprising:
receiving a mode selection from the user of a mode for preventing disturbance of the primary multimedia experience;
revising an instant messaging user interface by closing an instant messaging menu and minimizing a conversation window; and
receiving and recording incoming instant messages for the user.

23. The method of claim 22, further comprising sending the recorded messages to the user upon deactivation of the mode for preventing disturbance.

24. The method of claim 22, further comprising opening the instant messaging menu upon deactivation of the mode for preventing disturbance.

25. The method of claim 22, further comprising providing an animation to indicate to other users that the user has selected the mode for preventing disturbance.

26. The method of claim 22, further comprising providing the instant messaging menu with tools for accessing the conversation window.

27. The method of claim 22, further comprising providing a selectable button on the conversation window for accessing the instant messaging menu.

28. The method of claim 22, further comprising providing a quick reply option on the instant messaging menu for allowing the user to select one response from of a set of predetermined responses.

29. The method of claim 22, further comprising providing a contact list on the instant messaging menu for allowing the user to initiate a conversation and open a conversation window.

30. The method of claim 22, further comprising closing the instant messaging menu upon execution of any command from the instant messaging menu.

31. A computer readable medium storing computer executable instructions for performing the method of claim 22.

32. An instant messaging user interface for interaction with a remote control device for facilitating conversation during a primary entertainment experience, the instant messaging user interface comprising:
an instant messaging menu for initiating an instant messaging conversation during the primary entertainment experience; and
a conversation window for display in a peripheral portion of a screen displaying the primary entertainment experience, the conversation window comprising a text entry section and a conversation record for displaying conversation history.

33. The instant messaging user interface of claim 32, further comprising a show menu button on the conversation window for accessing the instant messaging menu.

34. The instant messaging user interface of claim 32, further comprising a selectable do not disturb mode on the instant messaging menu, wherein the do not disturb mode processes and records messages received during the primary entertainment experience.

35. The instant messaging user interface of claim 32, further comprising a quick reply option on the instant messaging menu for allowing the user to select one response from of a set of predetermined responses.

36. The instant messaging user interface of claim 32, further comprising a contact list on the instant messaging menu for allowing the user to initiate a conversation and open a conversation window.

37. The instant messaging user interface of claim 32, further comprising a message waiting notification symbol to notify the user that at least one message is waiting.

38. The instant messaging user interface of claim 32, further comprising a message waiting notification symbol having a varying appearance in order to convey message status.
